(19) United States
(12) Patent Application Publication
(10) Pub. No.: US 2008/0037286 A1
(43) Pub. Date: Feb. 14, 2008

(54) Connecting structure for cold cathode fluorescent tubes of backlight module

(76) Inventor: Chin-hwa Hwang, Taipei City (TW)

Correspondence Address: BACON & THOMAS, PLLC, 625 SLATERS LANE, FOURTH FLOOR, ALEXANDRIA, VA, 22314, US

(21) Appl. No.: 11/500,283

(22) Filed: Aug. 8, 2006

(51) Int. Cl. F21V 7/04

(52) U.S. Cl. 362/632

(57) ABSTRACT

A connecting structure for cold cathode fluorescent tubes of a backlight module provided to make the cold cathode fluorescent tubes in the backlight module have better connecting effect; the backlight module includes at least a controlling circuit board, at least one cold cathode fluorescent tube connecting with the controlling circuit board, each cold cathode fluorescent tube has more than one electrode connecting pin. Wherein a lateral edge of the controlling circuit board is provided with more than one connecting area for direct welding of the electrode connecting pins, the connecting areas at least have a leading end for leading and connecting the electrode connecting pins.

### BACKGROUND OF THE INVENTION

1. Field of the Invention

The present invention is related to a connecting structure for cold cathode fluorescent tubes of a backlight module, and especially to a connecting technique to make cold cathode fluorescent tubes in a backlight module have better connecting effect; it suits application on a liquid crystal display or other related backlight modules.

2. Description of the Prior Art

In the recent years, liquid crystal displays have gradually taken the place of the conventional displays having the key technique of cathode ray tube, and a technique of backlight module has been used to give rich light sources and colors in a limited space, such liquid crystal displays has the feature of lightness and thinness and is superior to the conventional displays.

And the backlight module abovementioned includes cold cathode fluorescent tubes for forming a light source, as shown in FIG. 1, members used in the connecting technique of the cold cathode fluorescent tubes include a controlling circuit board 10, at least a cold cathode fluorescent tube 20 connecting with the controlling circuit board 10, each cold cathode fluorescent tube 20 has more than one electrode connecting pin 21. The measures that the prior art uses to connect the controlling circuit board 10 with the cold cathode fluorescent tube 20 is that, the controlling circuit board 10 is provided in advance with more than one insertion socket 11, each insertion socket 11 is electrically connected to a conductive strip 12 provided on the controlling circuit board 10 and is provided at the tailing end of each cold cathode fluorescent tube 20 with an insertion plug 22, the insertion plugs 22 are used to integrate the electrode connecting pins 21 extending outwards; after an operator doing assembling inserts the insertion plugs 22 in the corresponding insertion sockets 11, the cold cathode fluorescent tube 20 can be electrically connected with the controlling circuit board 10.

However, such a structure to connect the cold cathode fluorescent tube 20 with the controlling circuit board 10 is completed by cooperation of the insertion sockets 11 and the insertion plugs 22, in this way, the prior art or a technique similar to the prior art may have the following problems in practicing:
1. It needs insertion sockets and the insertion plugs to thereby increase its cost of production, in addition to increasing of the cost of material, the costs of preparing materials, purchasing and examination of such industry can be increased too.
2. After combination of the insertion sockets and the insertion plugs, the originally smooth surface of the controlling circuit board will be evidently relieved, so that the applicable space of the controlling circuit board will be limited.
3. By virtue that the insertion sockets and the insertion plugs are relieved from the surface of the controlling circuit board, when a related heat sinking fan in a liquid crystal display blows wind forcedly, the insertion sockets and insertion plugs will form impedance against air flow, and this is subjected to having covering dust, and even having staying of bacteria and waste gas.
4. Metallic structures provided on the insertion sockets and the insertion plugs for electric connecting will have oxide films on their surfaces because of exposure and having electric current flow through them for a long time, the oxide films will increase the resistance of them to affect the life of use of the cold cathode fluorescent tube and to induce heat consumption, this not only wastes energy source, but also has a problem of becoming hot.
5. When the insertion sockets and the insertion plugs are badly contacted, a problem that the cold cathode fluorescent tube is unable to operate can be induced.

### SUMMARY OF THE INVENTION

In view of the problems induced by the prior art, the main gist of the present invention is to provide a connecting structure which is structurally simple, has good durability and high space applicability, and does not influence the heat sinking air flow.

The present invention is a connecting structure for cold cathode fluorescent tubes of a backlight module, the backlight module includes at least a controlling circuit board, at least a cold cathode fluorescent tube connecting with the controlling circuit board, each cold cathode fluorescent tube has more than one electrode connecting pin. Wherein a lateral edge of the controlling circuit board is provided with more than one connecting area for direct welding of the electrode connecting pins, each of the connecting areas at least has a leading end for leading and connecting the electrode connecting pins. The connecting areas are recessed notches on the abovementioned lateral edge of the controlling circuit board, or cut slits on the lateral edge of the controlling circuit board, the leading ends can be the tailing ends of conductive strips provided on the controlling circuit board.

In comparison with the prior art, the technical measure of the present invention has the following advantages:
1. It does not need an insertion socket or an insertion plug, thereby it effectively lowers its cost of production, in addition to saving the cost of material, the costs of preparing materials, purchasing and examination of such industry can be lowered too.
2. After connecting of the cold cathode fluorescent tubes with the controlling circuit board, no relieved state will result on the surface of the controlling circuit board, so that the applicable space of the controlling circuit board will be less limited.
3. There will be no problem of having covering dust or having staying of bacteria and waste gas.
4. Generating of surface oxide films can be effectively prevented, and the problems of increasing the resistance that may affect the life of use of the cold cathode fluorescent tubes and induce heat consumption etc can be solved.
5. There will be no problem of having bad contacting between the insertion sockets and the insertion plugs.

The present invention will be apparent in its technical measures after reading the detailed description of the preferred embodiment thereof in reference to the accompanying drawings.

### BRIEF DESCRIPTION OF THE DRAWINGS

FIG. 1 is a schematic perspective view of a prior art;

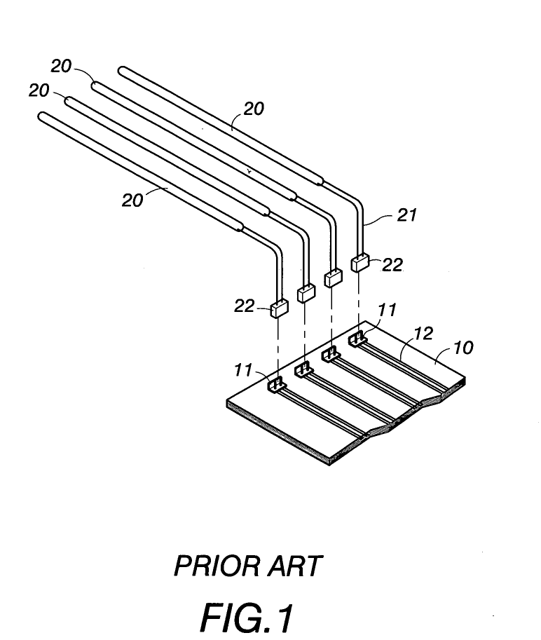

FIG. 2 is an anatomic perspective view of a preferred embodiment of the present invention;

FIG. 3 is a perspective view after assembling of the preferred embodiment of the present invention.

### DETAILED DESCRIPTION OF THE PREFERRED EMBODIMENT

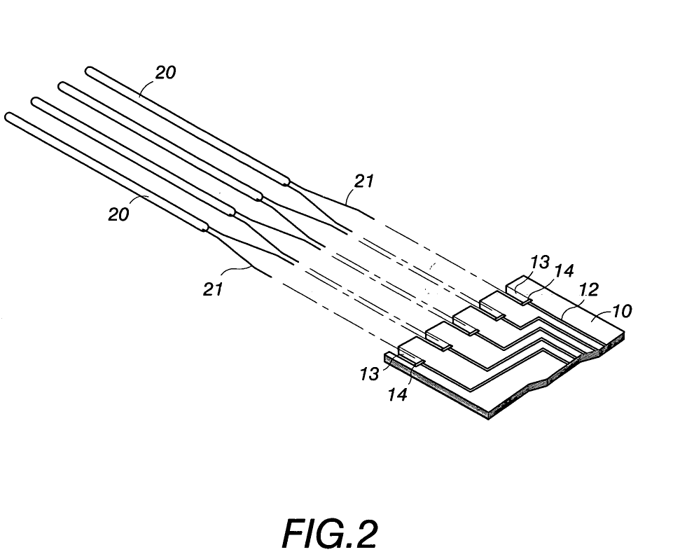

As shown in FIG. 2 which is an anatomic perspective view of a preferred embodiment of the present invention, it is depicted in the drawing with a preferred embodiment of a connecting structure for cold cathode fluorescent tubes of a backlight module. The connecting structure is located between a controlling circuit board 10 and the cold cathode fluorescent tubes 20, and comprises more than one connecting area 13 for fixedly welding thereto directly of electrode connecting pins 21 of the cold cathode fluorescent tubes 20; the connecting areas 13 are provided on one of the lateral sides of the controlling circuit board 10. Each of the connecting areas 13 has one or more than one leading end 14 for leading and connecting the electrode connecting pins 21; it is depicted in the drawing that each connecting area 13 has a leading end 14 for the convenience of explanation.

he leading ends 14 can be the tailing ends of conductive strips 12 provided on the controlling circuit board 10 or metallic sheets embedded in the ends of the conductive strips 12. Wherein the connecting areas 13 are tidily provided on the lateral edge of the controlling circuit board 10, and can be recessed notches on the lateral edge of the controlling circuit board 10, or cut slits or narrow seams on the lateral edge of the controlling circuit board 10. In this drawing, it is depicted for explanation with the recessed notches on the lateral edge of the controlling circuit board 10.

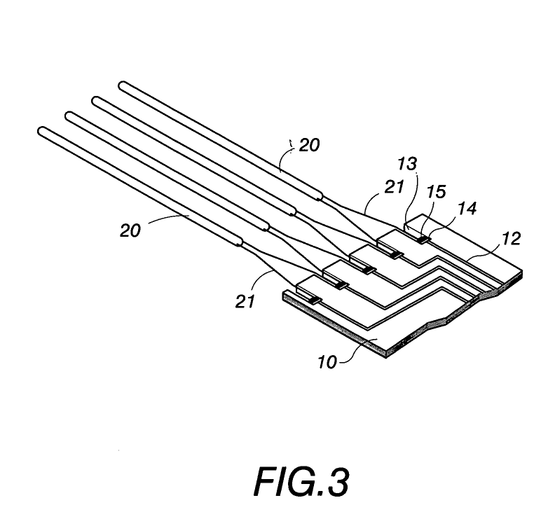

As shown in FIG. 3 which is a perspective view after assembling of the preferred embodiment of the present invention, wherein each cold cathode fluorescent tube 20 has two electrode connecting pins 21 that are respectively fixedly welded with solder 15 between every two neighboring connecting areas 13 directly, thereby a firm, non-separable and non-releasable connection state can be obtained, and each electrode connecting pin 21 and its corresponding leading end 14 can be kept in a good electric connection state.

Therefore, practicing of the present invention can effectively reduce the cost of production, save material, and can lower the costs of preparing materials, purchasing and examination. By virtue that the cold cathode fluorescent tubes 20 are connected laterally with the controlling circuit board 10, the surface of the controlling circuit board 10, the space of the present invention will be less limited, no problem of covering dust or influence on heat sinking etc. results.

Moreover, by virtue that the cold cathode fluorescent tubes 20 are connected laterally with the controlling circuit board 10, and the connecting areas of the electrode connecting pins 21 and its corresponding leading ends 14 are not enveloped by the solder 15, there will be no problem of generating of surface oxide films to influence good electric contact.

The above description and drawings of the embodiment given are only for illustrating the present invention, and not for giving any limitation to the scope of the present invention; it will be apparent to those skilled in this art that various equivalent modifications or changes without departing from the spirit of this invention in the structure, assembling and features etc. shall also fall within the scope of the appended claims.

1. A connecting structure for cold cathode fluorescent tubes of a backlight module, said backlight module includes at least a controlling circuit board, at least a cold cathode fluorescent tube connecting with said controlling circuit board, each of said cold cathode fluorescent tubes has more than one electrode connecting pin;
said connecting structure is located between said controlling circuit board and said cold cathode fluorescent tubes, and comprises more than one connecting area for fixedly welding thereto directly of electrode connecting pins of said cold cathode fluorescent tubes; said connecting areas are provided on one of two lateral sides of said controlling circuit board, each of said connecting areas at least has a leading end for leading and connecting said electrode connecting pins.

2. The connecting structure for cold cathode fluorescent tubes of a backlight module as in claim 1, wherein: said connecting areas are recessed notches on said edge of said controlling circuit board.

3. The connecting structure for cold cathode fluorescent tubes of a backlight module as in claim 1, wherein: said connecting areas are cut slits on said edge of said controlling circuit board.

4. The connecting structure for cold cathode fluorescent tubes of a backlight module as in claim 1, wherein: said connecting areas are narrow seams on said edge of said controlling circuit board.

5. The connecting structure for cold cathode fluorescent tubes of a backlight module as in claim 1, wherein: said leading ends are ends of conductive strips provided on said controlling circuit board.

6. The connecting structure for cold cathode fluorescent tubes of a backlight module as in claim 1, wherein: said leading ends are metallic sheets embedded in said controlling circuit board in connecting with ends of said conductive strips.
